(19) United States
(12) Patent Application Publication
(10) Pub. No.: US 2010/0222940 A1
(43) Pub. Date: Sep. 2, 2010

(54) LOCKING SYSTEM, ESPECIALLY BLUETOOTH CAR KEY

(76) Inventor: Felix Pütsch, Bergisch-Gladbach (DE)

Correspondence Address: Law Offices of Robert F. Zielinski, LLC, 1518 Walnut Street, Suite 1706, Philadelphia, PA, 19102, US

(21) Appl. No.: 12/682,600

(22) PCT Filed: Jun. 23, 2008
(86) PCT No.: PCT/EP2008/005050

§ 371 Date: Apr. 12, 2010

(30) Foreign Application Priority Data
Oct. 11, 2007 (DE) 10 2007 048 696.2

(51) Int. Cl. F02N 11/08; G06F 7/04; H04B 7/00

(52) U.S. Cl. 701/2; 340/5.61; 340/5.54; 455/41.2

(57) ABSTRACT

The invention relates to a locking system that is suitable for receiving an individual designation of a key via a wireless interface and, upon receipt of a corresponding key designation, to lock and/or unlock, wherein the key is a mobile communications terminal.

### CROSS-REFERENCE TO RELATED PATENT APPLICATIONS

The present application is a U.S. national stage application under 35 U.S.C. §371 of PCT Application No. PCT/EP2008/005050, filed Jun. 23, 2008, which in turn claims the priority benefit of German Patent Application No. 102007048696.2, filed Oct. 11, 2007, the entireties of which are incorporated herein by reference.

The invention relates to a locking system which is suitable for receiving an individual identifier of a key over a wireless interface and for locking and/or unlocking when a corresponding key identifier is received.

These locking systems in which there is wireless operation for opening a door are known. The disadvantage in the known locking systems which can be locked or unlocked over a wireless interface is that for each locking system an individual key must be carried; in a majority of locking systems this leads to a corresponding number of keys which a user must carry.

Furthermore, in the known locking systems the limited number of keys to the respective locking system is disadvantageous so that according to the prior art only with the enlistment of the manufacturer is it possible to expand the pool of keys by means of which the locking system can be actuated Likewise it is disadvantageous in the known locking systems that it is not easily possible to change the identifier for actuating the locking system when a key is lost or has been stolen.

The object of the invention is to overcome these disadvantages of known locking systems, especially to enable easy implementation of a pool of keys to a locking system.

This object is achieved as claimed in the invention by a locking system as claimed in claim 1.

In the locking system as claimed in the invention which is suitable for obtaining an individual identifier of a key over a wireless interface, and for locking and/or unlocking upon reception of a corresponding key identifier, it is advantageous that the key is a cellular terminal.

It is common nowadays that almost everyone has a cellular terminal such as a cellphone or the like, so that when using this cellular terminal as a key to a locking system an additional device in the form of a key individually assigned to the locking system need not be carried.

It is furthermore advantageous in the locking system as claimed in the invention that a majority of cellular terminals can be coupled to the locking system via individual identifiers so that it is possible to produce a pool of keys by means of which the locking system can be actuated.

Conversely, there is a major advantage in an individual cellular terminal being used as a key for different locking systems and thus the number of keys to be carried for different locking systems or locking installations being able to be reduced to only a single one as a key for several locking systems.

Other advantageous embodiments of the invention are given in the dependent claims.

Preferably the locking system has an identifier generator by means of which an identifier can be generated and transmitted to the cellular terminal when started up for the first time and/or on request.

The cellular terminal, for example a cellphone, is thus equipped with a key in which in the first-time coupling to the locking system or for triggering of a corresponding function of the locking system it is provided with an individual key, i.e. a “private key”. This individual identifier is stored in the cellular terminal.

Preferably the wireless interface is a Bluetooth connection. In particular the connection can have an individual Bluetooth profile, as is conventional in known Bluetooth connections that there are for example profiles for headsets, hands-free devices, etc.

The “pairing” of the cell phones, i.e. of the cellular terminal, with the locking system can for example proceed such that in the pairing of a Bluetooth headset with the cell phone, i.e.: 1. Place the locking system physically on “pairing readiness”. 2. Locking system outputs the pairing PIN. 3. Initiate pairing on the cell phone and manually input the PIN. After completion of this process the cellular terminal is then ready for use as a key for a locking system and the locking system can be for example automatically unlocked as soon as a Bluetooth connection between the locking system or locking installation and the cell phone, i.e. the cellular terminal, has been established.

In one preferred embodiment of the locking system as claimed in the invention, there is a majority of keys and/or a majority of individual identifiers by means of which the locking system can be locked and/or unlocked. In this way it is easily possible to generate and manage a larger pool of keys by means of which the locking system can be actuated.

Preferably the identifier of a key can be protected by a personal identification number (PIN). In this way an additional protection function can be implemented in which wireless transmission of the individual key by the cellular terminal only takes place when a personal identification number is input and/or in addition to the individual identifier of the key is transmitted to the locking system over the wireless interface. In this way an increased security level can be created.

In one preferred embodiment and application of the locking system as claimed in the invention, it is the locking system of a motor vehicle, especially the engine of the vehicle that can be started by means of the cellular terminal.

For this purpose, the vehicle is equipped with a Bluetooth receiver, the cellular terminal, i.e. the cell phone, having a Bluetooth interface and being equipped with corresponding key software.

The cell phone is coupled one time to the vehicle and is equipped with an individual key, i.e. a private key.

Provided that the cellular terminal is approaching the vehicle, i.e. is travelling into the range of the Bluetooth receiver of the vehicle, a Bluetooth connection is automatically established between the vehicle and the cellular terminal. The vehicle sends an inquiry to the cellular terminal, whereupon the cellular terminal sends a corresponding answer, this answer containing the individual identifier as the key. If the key agrees with a stored key of the locking system, the doors of the vehicle are unlocked. In one advantageous development it is then possible to start the engine by menu on the cellular terminal since in this case the immobilizer of the vehicle can be unlocked by means of the locking system and the engine can be started. Alternatively it is also possible to couple the immobilizer to the locking system, i.e. at the same time to unlock with the doors of the vehicle and to start the engine by way of a starting button in the car.

Here it is advantageous that in the locking system as claimed in the invention a separate key is no longer needed and it is possible to generate keys for any number of co-users of the vehicle; this is very advantageous for management of vehicle pools, for example in larger businesses.

In a case of theft or loss of the key, the individual identifiers to which the locking system reacts can be changed. Optionally the Bluetooth key can be protected by a personal identification number (PIN), by which an additional security stage can be implemented. Alternatively or cumulatively it is possible to block the individual identifier of one or more keys as access on the side of the locking system in order to prevent actuation of the locking system in a loss or theft of the key.

This can take place for example by the locking system being actuated by means of another key from the key pool and then directly on the locking system blocking a certain (the stolen) key, for example by this selected key or alternatively all existing keys being blocked by “unpairing” the keys and locking system. If the locking system has a key generator, a new pairing of the locking system to one or more keys using the key identifiers can take place in a simple and advantageous manner.

1. A locking system which is suitable for receiving an individual identifier of a key over a wireless interface and for locking and/or unlocking when a corresponding key identifier is received, characterized in that the key is a cellular terminal.

2. A locking system as claimed in claim 1, wherein the locking system has an identifier generator by means of which an identifier can be generated and transmitted to the cellular terminal when started up for the first time and/or on request.

3. A locking system as claimed in claim 1, wherein the wireless interface is a Bluetooth connection, in particular wherein the connection has an individual Bluetooth profile.

4. A locking system as claimed in claim 1, wherein there is a majority of keys and/or a majority of individual identifiers by means of which the locking system can be locked and/or unlocked.

5. A locking system as claimed in claim 1, wherein the identifier of a key can be protected by a personal identification number (PIN).

6. A locking system as claimed in claim 1, wherein it is the locking system of a motor vehicle, especially wherein the engine of the vehicle can be started by means of the cellular terminal.

7. A locking system as claimed in claim 1, wherein the individual identifier of one or more keys as access can be blocked on the side of the locking system.

8. A locking system as claimed in claim 2, wherein the wireless interface is a Bluetooth connection, in particular wherein the connection has an individual Bluetooth profile.

9. A locking system as claimed in claim 2, wherein there is a majority of keys and/or a majority of individual identifiers by means of which the locking system can be locked and/or unlocked.

10. A locking system as claimed in claim 2, wherein the identifier of a key can be protected by a personal identification number (PIN).

11. A locking system as claimed in claim 2, wherein it is the locking system of a motor vehicle, especially wherein the engine of the vehicle can be started by means of the cellular terminal.

12. A locking system as claimed in claim 2, wherein the individual identifier of one or more keys as access can be blocked on the side of the locking system.
